(19) United States
(12) Patent Application Publication
(10) Pub. No.: US 2002/0046970 A1
(43) Pub. Date: Apr. 25, 2002

(54) Porous membrane

(75) Inventors: Kei Murase, Hiroshima (JP); Hideaki Habara, Hiroshima (JP); Hiroyuki Fujiki, Hiroshima (JP); Takeshi Hirane, Hiroshima (JP); Masahiko Mizuta, Hiroshima (JP)

Correspondence Address: FITCH EVEN TABIN AND FLANNERY, 120 SOUTH LA SALLE STREET, SUITE 1600, CHICAGO, IL, 60603-3406, US

(73) Assignee: Mitsubishi Rayon Co., Ltd., Tokyo (JP)

(21) Appl. No.: 09/956,599

(22) Filed: Sep. 20, 2001

(30) Foreign Application Priority Data
Sep. 21, 2000 (JP) 2000-287044
Sep. 4, 2001 (JP) 2001-267301

(51) Int. Cl. B01D 63/02

(52) U.S. Cl. 210/483; 210/500.23; 210/505

(57) ABSTRACT

An object of the present invention is to provide a porous membrane which has a superior separation performance and a high permeation performance, as well as a high mechanical physical property, in particular, a high tensile/rupture strength.

A porous membrane (1) of the present invention comprises a porous body (2) which has a plurality of pores communicated from one surface to the other surface, and a reinforcement fiber (3). In the porous body (2), the reinforcement fiber exists linearly and continuously between both end faces orthogonal to its permeation direction. Namely, in two different surface positions (A, B) within the same surface of the porous body, the surface position (A) has the reinforcement fiber (3) at a sectional region containing the surface position (A), while the surface position (B) does not have the reinforcement fiber (3) at a sectional region containing the surface position (B).

### TECHNICAL FIELD

The present invention relates to a porous membrane suitable for water treatment as microfiltration membrane and ultrafiltration membrane. More specifically, the present invention relates to a porous membrane having a superior mechanical physical property while keeping both separation performance and permeation performance.

### BACKGROUND ART

Water treatment, for example, such as treatments of industrial waste water, sewerage, purified water and the like by a membrane method using a filtration membrane, which is superior in completion of separation and compactness, has been recently paid attention to because of an increase of interest in environmental pollution and reinforcement of regulation. In use of such water treatment, the filtration membrane is required for not only being superior in separation performance and permeation performance, but also for having a high mechanical property than hitherto.

Conventionally, as the filtration membrane superior in permeation performance, there is a filtration membrane made of polysulfone, polyacrylonitrile, cellulose acetate, polyvinylidene fluoride or the like, which is produced by a wet or dry-wet spinning method. This filtration membrane is produced by separating polymer solution in micro phase and then coagulating the same polymer solution in non solvent, so that it comprises a dense layer and a supporting layer. Therefore, it is possible to obtain a filtration membrane having a high porosity, as well as an asymmetric structure. Thus, it sometimes exhibits a high water permeability of 100 m³/m²/h/MPa or more.

However, the filtration membrane has substantially a low volumetric ratio of polymer (polymer volume occupied in an apparent volume of a filtration membrane). Further, since it is produced by being separated in micro phase, a sufficient molecular orientation is not obtained, and tensile/rupture strength of the filtration membrane is as little as about several MPas. Although the strength of this filtration membrane can be improved by enhancing the volumetric ratio of polymer and making a skeleton structure of the membrane thick, there occurs such a problem that the permeation performance is lowered in accordance with the improvement.

Further, as a method of improving the strength of this filtration membrane, a method using a high molecular weight polymer is disclosed in Japanese Patent Application Laid-Open No. 63-190012.

On the other hand, according to a production process of a polysulfone hollow fiber membrane, which is for example disclosed in Japanese Patent Application Laid-Open No. 3-196823, the tensile strength is improved while keeping a high permeation performance by limiting an addition amount of a polyethylene glycol having a comparatively low molecular weight, which is 200 to 10000 at mean molecular weight, by means of adding polyhydric alcohol that is non solvent of polysufone to raw liquid for the membrane production.

Further, in the case of a polysulfone hollow fiber membrane disclosed in Japanese Patent Application Laid-Open No. 4-260424, the polysulfone is dissolved in a solution of polyethylene glycol, which has a remarkably large value of an average molecular weight that is 150000 to 2 million, to obtain raw liquid for spinning. Since the polyethylene glycol has a normal stress effect, the raw liquid for spinning discharged from a nozzle is abruptly swollen in a radial direction, and the polysulfone molecules orient not only in a textile axis direction but also in a circumferential direction. Therefore, it is held that well-arranged holes are formed at an inner face and an outer face of the hollow fiber membrane.

Further, according to a production process of a polysulfone hollow fiber membrane disclosed in Japanese Patent Application Laid-Open No. 7-163847, a behavior of spinodal decomposition (phase separation) is controlled. Specifically, the temperature of raw liquid of the membrane production is adjusted at a temperature that is higher than an upper phase separation temperature (when it exceeds this temperature, it becomes a solution separated in two phases from a homogeneous solution) and lower than a lower phase separation temperature (when it becomes lower than this temperature, it becomes a solution separated in two phases from a homogeneous solution), to obtain an inhomogeneous solution, and then the solution is discharged from a nozzle. The hollow fiber membrane obtained by such a method has a large mean pore diameter, and the polysulfone skeleton becomes thick, so that both of the tensile strength and the permeability speed of water are improved.

However, each of these hollow fiber membranes only has a tensile/rupture strength of about 5 to 10 Mpa. Therefore, it cannot be said that the strength is sufficient for a filtration membrane to be used under sever conditions such as for water treatment for industry.

Accordingly, as a production method of producing a filtration membrane having comparatively a high strength, there is a method of melting polyethylene, polypropylene or the like to be formed, and then making plural pores by extension. However, since the structure of the membrane produced by such a method is a homogeneous structure which has no distribution of pore diameters in a sectional direction of the membrane and uniform pore diameters, it is difficult to obtain a sufficient permeation performance, and it could not be said that it has a sufficient permeation performance as a membrane for an industrial water treatment.

Additionally, as a separating material with a high strength, a complex membrane of a porous material with textile products such as a woven cloth, a non woven cloth, a braid or the like has been conventionally disclosed. For example, in the case of a semi-permeable complex membrane disclosed in Japanese Patent Application Laid-Open No. 53-132478, when the membrane is a flat shape or a tubular shape, a cloth is buried as a skeleton material (reinforcing material) entirely in their membrane walls, and when the membrane is a hollow fiber shape, a hollow braid is buried as a skeleton material (reinforcing material) entirely in its membrane walls.

Further, in the case of a semi-permeable membrane disclosed in Japanese Patent Application Laid-Open No. 52-82682, a cloth for reinforcement is completely buried in the semi-permeable membrane. Further, at least one side face of the cloth exists on a surface of the semi-permeable membrane, such that it is buried so as to exist in an inside of an inclined porous layer or a dense layer which tends to be shrunk by hot water treatment or dry-heat treatment, or in the vicinity of those layers.

A complex body of porous membrane disclosed in Japanese Patent Application Laid-Open No. 64-15102 comprises a layer of porous membrane consisting of an acrylonitrile-based polymer having a three dimensional knit structure and a supporting layer, which is bonded on one face of the same porous membrane and is composed of a non woven cloth or a woven or knit fabric so that it has air permeability and water permeability.

Further, Japanese Patent Application Laid-Open No. 5-301031 discloses a method of producing a membrane having both side flat face by passing and sandwiching a sheet-like supporting body in a solution for forming the membrane and coating the solution for forming the membrane on the whole both side faces of the supporting body. As the sheet-like supporting body, there are mentioned those that can be obtained by integrally forming an inner layer of a sparse structure such as a non woven fabric, a mesh screen, a net or the like with a surface layer consisting of a non woven fabric with a dense structure.

Meanwhile, water treatment with these porous membranes, in particular, water treatment for industry, includes not only a simple filtration but also a washing treatment and a sterilizing treatment, which are periodically carried out. These treatments put the porous membrane under a severe environment. For example, a great facial pressure is applied to the porous membrane in a permeation direction thereof during filtration, which would deform the porous membrane by expansion. Accordingly, it is necessary to secure an adequate strength against such deformation. However, a stress generated during the filtration is limited to a permeation direction, and the facial pressure can be estimated. Therefore, it is possible to obtain a required mechanical strength by the reinforcing porous membrane having a reinforcing fiber substrate, which is disclosed in the above publication, only if the lowering of permeation performance is ignored. On the other hand, during the bubbling at the washing and the sterilizing, a complex and large stress, which caused by a high order wave vibration, acts on the porous membrane repeatedly. This vibration demands a large tensile/rupture strength against supporting ends of the porous membrane fixed and supported by a supporting member.

Further, although the tensile/rupture strength of the complex membrane reinforced by the reinforcing fiber substrate such as a woven cloth, a non woven cloth, a braid or the like as mentioned above is improved, there has occurred such problems that any of the complex membranes lowers its separation performance and permeation performance, which are caused by ununiformity of the substrate made of fiber which is buried in or attached to the whole membrane, and that the applied porous layer is deformed, especially the porous layer is ruptured due to bending, so that it is separated from the fiber product. Therefore, this is not sufficient to exhibit an essential function as a porous membrane.

In addition to the above publications, Japanese Patent Application Laid-Open No. 11-319519, for example, discloses a membrane of spirally arranging a fiber in the membrane thickness of a hollow fiber membrane for the purpose of improvement of a burst pressure. However, although the reinforcing structure is surely effective for the improvement of a burst pressure, the fiber spirally arranged does not effectively act for improvement of a strength against a tensile direction until it becomes a linear shape. To the contrary, there are such problems that the hollow fiber membrane is crushed by being fastened by the fiber to its inner part, fall-down in the hollow of the fiber and the breakage of the membrane caused thereby occur.

The present invention is to solve these conventional problems. An object of the invention is to provide a porous membrane which has an excellent separation performance and a high permeation performance, and has also a high mechanical physical property.

### DISCLOSURE OF THE INVENTION

The present inventors have extensively studied in order to attain the object. As a result, the inventors obtained a porous membrane which can remarkably improve the mechanical physical property while securing the high separation performance and permeation performance.

Namely, a main feature of the present invention is in a porous membrane comprising a porous body having a plurality of pores communicated from one surface to the other surface thereof, and a reinforcement fiber, wherein at least one reinforcement fiber is linearly arranged penetrating both opposite ends orthogonal to a permeation direction of the porous body, a part of the fiber is exposed on the surface of the porous body or all of the fiber is buried in the porous body to be continuously extended, and a region which contains a cross-section of the fiber and a region which does not contain the cross section exist on a section of the porous body orthogonal to an extension direction of the fiber.

Specifically, there is provided a porous membrane comprising a porous body having a plurality of pores communicated from one surface to the other surface thereof, and a reinforcement fiber, wherein a part of the reinforcement fiber is exposed on the surface of the porous body to be buried, or all of the fiber is extended in a completely buried condition. The extended reinforcement fiber may be at least one, and the respective fibers are linearly continuous to the both opposite ends of the porous body. As a result, a region in which a side sectional face of the fiber are revealed and a region in which they are not revealed are disposed on the section of the porous body orthogonal to the extension direction of the fiber.

According to the porous membrane of the present invention, to simultaneously pursue the permeation performance and the mechanical physical property has no longer been done. Instead, the respective roles are shared, namely the fiber buried inside of the membrane serve for improvement of the mechanical physical property and the porous body serves for the permeation performance. Therefore, the problems could be solved

In a conventional porous membrane that is reinforced by a substrate made of fibers such as, for example, a woven cloth, a non woven cloth, a braid or the like being buried in or attached to all of the faces orthogonal to the permeation direction of the porous membrane, the lowering of the permeation performance tends to occur because of such problems that the substrate made of fibers becomes a filtration resistance or that the porosity and an opening pore ratio of the porous body are lowered at a conjunction part of the porous body with the fiber. Further, the deformation of the porous body, particularly, the destruction and separating of the porous body against bending tends to occur.

To the contrary, according to the present invention, no fiber exists in a sectional region including a certain surface, and there is a sectional region part which is not reinforced by a fiber, therefore an adequate permeation performance as the porous body can be kept.

The porous body is preferably a hollow fiber shape, and the fiber is extended in parallel with a hollow axis line. Or, the porous body may be a flat plate shape, in which case the reinforcement fiber is preferably arranged orthogonally to a permeation direction between the end faces opposite to each other.

As for a structure of the porous body according to the present invention, there may only be a plurality of pores communicated from one surface to the other surface, such that water or other liquid is permeable through the pores from one surface of the porous body to the other surface thereof. Therefore, the pores of the porous body may be linearly penetrated pores or pores having complicated network structures inside thereof. Further, although there may be applied a uniform structure with a uniform pore diameter having no pore diameter distribution in the thickness direction of the porous body, it is more preferable to be a heterogeneous structure having a pore diameter distribution.

In the case of the heterogeneous structure, the porous body is preferably an inclined-type three-dimensional network structure comprising a dense layer having a separation characteristic and a supporting layer contiguous to the dense layer and having gradually increasing pore diameters. With the inclined-type three-dimensional network structure, the dense layer having great influence on the permeation coefficient can be made thin, and the degree of dispersion of the pores is homogenized. Further, since all the pores are connected to each other, the permeation performance is preferably improved and homogenized. Accordingly, the pressure of a liquid flowing inside of the porous membrane is homogenized, so that a homogeneous filtration can be carried out over all regions of the porous membrane.

Further, in the case of the porous body having a reinforcement fiber therein, since the pores are three-dimensionally connected to each other, the obstruction of a flow path by the fiber can be lowered.

Further, the porous body is preferably composed of fluorine-based resin. The fluorine-based resin is superior in heat resistance and chemical resistance. In particular, the polyvinylidene fluoride-based resin is superior in bending resistance, and is suitable for sterilization which is repeatedly carried out in use, for washing by chemicals or aeration in order to cure the clogging of the membrane, and the like.

In addition, the form and the material of the porous body in the present invention can be appropriately changed in accordance with its application. Therefore, it should not be limited to the forms and the materials as mentioned above. However, it is important that the reinforcement fiber in the present invention is linearly and continuously extended between supporting members for supporting the opposite ends of the porous membrane. Therefore, the reinforcement fiber is linearly extended penetrating the opposite end faces of the porous body.

Further, only if there is a linearly continuous reinforcement fiber, a fiber which is crossed orthogonally or obliquely thereto may be further provided.

The material of the porous body according to the present invention is not specifically limited. It may be polysufone-based resin, polyacrylonitrile, cellulose derivative, polyolefin such as polyethylene, polypropylene or the like, fluorine-based resin such as polyvinylidene fluoride, a polytetrafluoroethylene or the like, polyamide, polyester, polymethacrylate, a polyacrylate and the like. Further, it may be a copolymer of these resins, or a polymer in which a substituent has been partially introduced. Furthermore, it may be a mixture of two or more of resins.

Further, what is characteristic is that the relation of the pure water permeation coefficient of the porous body with a bubble point when ethyl alcohol is used as a measurement medium satisfies the following equation (I) and the tensile-rupture strength is 10 MPa or more:

WF≧10000/BP (I)

wherein WF denotes a pure water permeation coefficient (m³/m²/hr/MPa), and BP denotes a bubble point (kPa).

WF≧20000/BP is preferable. When the right side of the equation (I) is less than 10000/BP, a high pressure is required for obtaining a sufficient permeation amount in such an application as water treatment and the like. As a result, it is not preferable because it induces acceleration of clogging of the membrane surface and an increase of the operational cost.

When the membrane is used for water treatment, in particular as a submersion-suctiontype module whose box body is not filled, it is required that the liquid of the primary side of the membrane permeation is fluidized against the membrane surface. Since the membrane receives swinging and tension by resistance with the membrane surface flow, a tensile/rupture strength of at least 10 MPa or more, preferably 20 MPa or more, is required in order to endure this.

It is required that the membrane thickness is made thin, or the porosity is raised in order to enlarge the pure water permeation coefficient with the same bubble point, namely the same pore diameter. Accordingly, when a performance satisfying the equation (I) is satisfied, it was difficult to keep a sufficient mechanical strength so that it could not endure a severe use such as water treatment or the like. However, according to the present invention, a thin membrane satisfying the equation (I) can be obtained by the reinforcement fiber serving for the mechanical strength.

In addition, even if the reinforcement fiber having a shape of a braid is used for example, it is possible to use the membrane for the water treatment use as far as it satisfies the equation (I) and has a tensile/rupture strength of 10 MPa or more.

The bubble point is preferably 50 kPa or more. When the bubble point BP in the equation (I) is 50 kPa or less, it is not preferable in practical use because bacteria such as coli bacillus or the like and suspended substance is allowed to permeate.

Further, the thickness of the reinforcement fiber is preferably 10 to 300 μm. When the thickness of the reinforcement fiber is less than 10 μm, a sufficient mechanical strength can not be obtained. When it exceeds 300 μm, the thickness which is required for the porous body to contain the reinforcement fiber becomes too thick. Therefore, it is not preferable because the pure water permeation coefficient is lowered.

Further, the shape of the reinforcement fiber according to the present invention may be any one of a monofilament, a multifilament and a spun yarn. Further, the reinforcement fiber may be any one of a round cross-section yarn, a hollow fiber and a varied cross-section yarn. Furthermore, the number of these monofilaments, multi filaments or spun yarns may be one or more. Therefore, it can be appropriately changed according to the physical property required for the use of an object.

All or a part of the fiber in the present invention may exist inside of the porous body. However, from the viewpoint of completeness of the membrane separation and improvement of the mechanical physical property, it is preferable that the fiber exists so as to be completely buried inside of the porous body.

It is important that the reinforcement fiber in the present invention is linearly and continuously extended between both end faces orthogonal to the permeation direction of the porous body. The present invention is characterized in that the fiber existing inside of the porous body serves for fluctuation of the tensile strength applied to between the both end faces orthogonal to the permeation direction of the porous membrane, which is generated particularly during permeation and washing. Therefore, according to the present invention, it is most important that the fiber is linearly arranged between the both ends orthogonal to the permeation direction of the porous body.

When the fiber is only arranged in bending or spirally, the fiber firstly tries to take a linear mode when the tensile stress is applied to the membrane, therefore it does not contribute to support the above-mentioned tensile stress, so that the porous body supports the stress while the fiber is going to take a linear mode. Therefore, it is not preferable because the porous body is destroyed before the fiber becomes linear to support the stress.

For example, when the porous body is in a hollow fiber shape, it is preferable that the fiber exists linearly and continuously along the axis line of the hollow fiber. Further, when the porous body is in a flat plate shape, it is preferable that the fiber is linearly and continuously to the ends, in such a manner that it is arranged in parallel or mutually orthogonally between two sufficiently separated cross-sections orthogonal to the flat plate. Accordingly, it is not preferable that staples are discontinuously dispersed inside of the porous body, or fibers only exist in largely bent state, because an adequate mechanical physical property as the porous membrane can not be obtained.

It is possible to employ a natural fiber, a semi-synthetic fiber, a synthetic fiber, a regenerated fiber, an inorganic fiber or the like as the fiber in the present invention.

As typical examples of the synthetic fiber, there can be mentioned various polyamide-based fibers such as nylon 6, nylon 66, aromatic polyamide and the like; various polyester-based fibers such as polyethylene terephthalate, polybutylene terephthalate, polylactic acid, polyglycolic acid and the like; various acryl-based fibers such as polyacryl nitrile and the like; various polyolefin-based fibers such as polyethylene, polypropylene and the like; various polyvinyl alcohol-based fibers; various polyvinylidene chloride-based fibers; polyvinyl chloride-based fibers; various polyurethane-based fibers; polyphenol-based fibers; fluorine-based fibers consisting of polyvinylidene fluoride, polytetrafluoroethylene and the like; various polyalkylene p-oxybenzoate-based fibers, and the like.

As typical examples of the semi-synthetic fiber, there can be mentioned various cellulose derivative-based fibers using diacetate, triactate, chitin, chitosan and the like as raw material; various protein-based fibers called as promix, and the like.

As typical examples of the regenerated fiber, there can be mentioned various cellulose-based regenerated fibers (rayon, cupra, polynosic and the like) obtained by a viscose method, a copper-ammonia method, or an organic solvent method and the like.

As typical examples of the natural fiber, flax, ramie, jute and the like can be mentioned. Since these plant fibers indicate a hollow fiber mode, they can be used for the present invention.

As typical examples of the inorganic fiber, a glass fiber, a carbon fiber, various metal fibers and the like can be mentioned.

The reinforcement fiber is preferably constituted by polyester-based resin in particular. Since the polyester-based resin has a high strength and chemical resistance, and is cheap, it is suitable for the material of the reinforcement fiber.

Tthe thickness of the reinforcement fiber is more preferably 50 to 200 μm.

The tensile modulus of the reinforcement fiber is preferably higher than the tensile modulus of the porous body.

As to the physical property of the fiber in the present invention, it is preferable that the tensile modulus is higher than the tensile modulus of the porous body, for a purpose of reinforcing the porous body. When the tensile modulus of the fiber is lower than the tensile modulus of the porous body, mainly the porous body receives a stress at the time of deforming, so that the improvement of strength is small.

It is preferable that the tensile modulus of the reinforcement fiber is two times or more as large as the tensile modulus of the porous body, more preferably five times or more. Further, the tensile modulus of the reinforcement fiber is preferably 0.1 GPa or more.

The tensile/rupture ductility of the porous body is set to be higher than the tensile/rupture ductility of the reinforcement fiber. Since the rupture of the porous body hardly occurs before the rupture of the reinforcement fiber when the membrane receives a tensile stress, it is preferable that the tensile/rupture ductility of the porous body is higher than the tensile/rupture ductility of the reinforcement fiber. It is preferable that the tensile-rupture ductility of the porous body is 1.2 times or more as large as the tensile/rupture ductility of the reinforcement fiber. Specifically, the tensile/rupture ductility of the porous body is preferably 30% or more.

The projection area of the reinforcement fiber with respect to the membrane area of the porous body is preferably 20% or less. Further, it is preferably 10% or less.

Here, the membrane area of the porous body is an area of a plane perpendicular to the permeation direction of the filtration fluid. When the shape of the porous membrane is a flat plate shape, it is either of the surface areas. When it is a hollow shape, it is a surface area that can be obtained by its outer diameter. Further, the projection area of the reinforcement fiber is a projection area of the reinforcement fiber buried in the porous body with respect to a membrane plane, and is substantially equal to a projection area that can be obtained by the thickness of the reinforcement fiber.

When the projection area of the reinforcement fiber exceeds 20% or more, it becomes resistance when the liquid passes the membrane. Therefore, the original permeation performance of the porous body cannot be adequately exhibited. On the other hand, when it is 20% or less, such influence does hardly occur. Further, when the membrane is an asymmetric membrane in which the porous body has a dense layer on a surface thereof and has a supporting layer including a large pore diameter in the inner part thereof, the permeation characteristic is hardly influenced when the projection area of the reinforcement fiber is 20% or less.

In addition, in order to produce the porous membrane according to the present invention, when the reinforcement fiber is a hollow fiber shape for example, it is possible to produce the porous body with the fiber existing inside thereof by simultaneously extruding the fiber from the sheath part of a double ring nozzle from which polymer solution is to be extruded, according to a method of extruding the polymer solution from the sheath part of the double ring nozzle together with an inner coagulation liquid and bringing it into contact with the coagulation liquid immediately or after passage of an appropriate dry distance. However, the production method of the porous membrane of the present invention should not be limited to the method.

### DESCRIPTION OF THE DRAWINGS

FIG. 1 is a perspective view by seeing through an inside of a flat plate fiber-reinforced porous membrane according to the present invention.

FIG. 2 is a sectional view taken along the X-Y line of FIG. 1.

FIG. 3 is a perspective view by seeing through an inside of a fiber-reinforced porous hollow fiber membrane with a hollow fiber-shape according to the present invention.

FIG. 4 is a sectional view of the same porous membrane.

FIG. 5 is a perspective view by seeing through an inside of a fiber-reinforced porous hollow fiber membrane with a hollow fiber shape according to the present invention.

FIG. 6 is a sectional view of the same porous membrane.

FIG. 7 is a magnified sectional photo of the hollow fiber membrane that has been obtained according to the third embodiment.

### BEST MODE FOR CARRYING OUT THE INVENTION

Embodiments for carrying out the present invention will be illustrated in detail below with reference to the drawings.

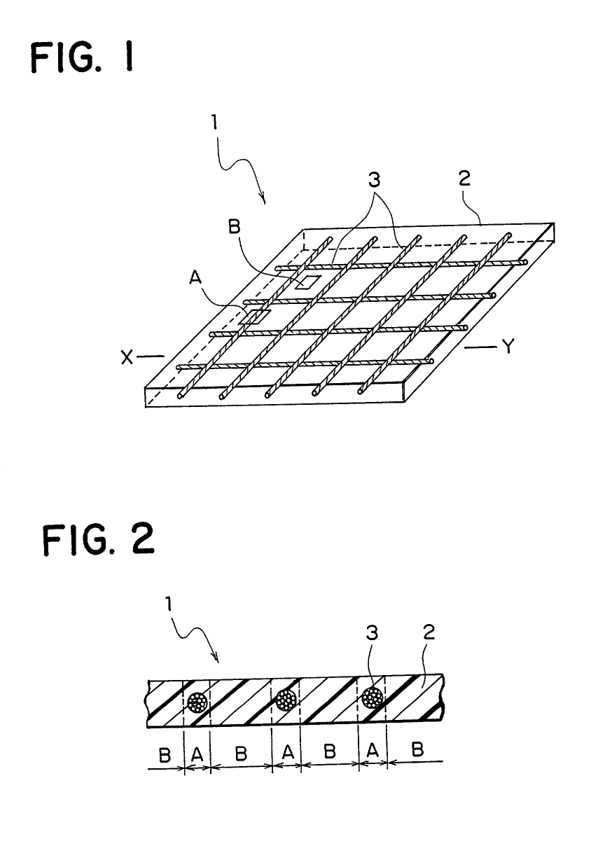

FIG. 1 is a perspective view showing an inside of a preferred porous membrane according to the present invention, and FIG. 2 is a sectional view taken along the X-Y line of FIG. 1.

A porous membrane 1 shown in FIG. 1 is a flat plate shape. The same porous membrane 1 is constituted by a porous body 2 which has pores penetrated from an upper face to a lower face of the flat plate as viewed in FIG. 1, and reinforcement fibers 3 buried in the same porous body 2.

The reinforcement fiber 3 in the present embodiment is a spun yarn. In the inside of the porous body 2, a plurality of spun yarns as the reinforcement fibers 3 are linearly and continuously arranged between opposite end faces of the porous body so as to be arranged in a lattice shape with constant intervals as a whole to be buried therein. Accordingly, in two different surface positions A and B on the same surface of the porous body 2, while at the surface position A the reinforcement fibers 3 exist in the inside of a sectional region in a thickness direction including the surface A, at the surface position B, the reinforcement fibers 3 do not exist in the inside of a sectional region in a thickness direction including the surface B. Namely, a portion in which the porous membrane 1 is reinforced by the reinforcement fibers 3 and a portion in which the porous membrane 1 is not reinforced exist alternately.

In addition, although the reinforcement fiber 3 is arranged in a lattice shape in the present embodiment, as far as the porous membrane 1 has the reinforcement fibers linearly and continuously arranged between the opposite end faces of the porous body 2, there may be arranged reinforcement fibers which obliquely cross the reinforcement fibers linearly arranged.

Further, the porous body 2 has dense layers which have separation characteristic on a front surface and a back surface thereof, and a supporting layer exists between the both dense layers. The supporting layer gradually increases pore diameters from the dense layers to a center of the supporting layer. In the porous body 2 having such an inclined three-dimensional network structure, the degree of pore dispersion is uniformed, as well as all the pores are communicated, so that the permeation performance is improved and uniformed. Accordingly, the pressure of a fluid flowing in the inside of the porous membrane is uniformed, and a uniform filtration can be carried out at all regions of the porous membrane.

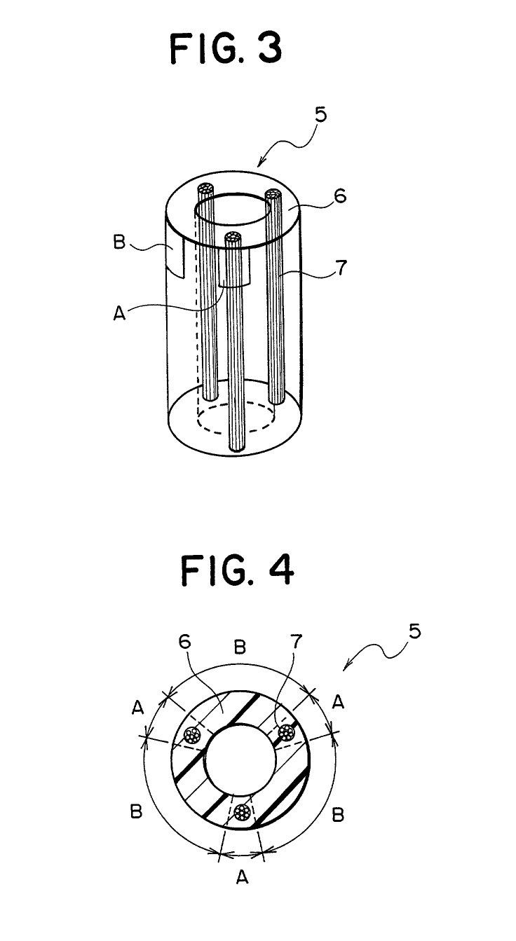

FIG. 3 is a perspective view by seeing through the inside of another preferable porous membrane 5 according to the present invention, and FIG. 4 is a sectional view of the same porous membrane 5.

The porous membrane 5 shown in FIG. 3 and FIG. 4 is a hollow fiber shape. The porous membrane 5 according to the present embodiment is composed of a porous body 6 having a number of pores penetrated from a hollowed inside of the hollow fiber to the outside of the hollow fiber, and a multi-filament yarn 7 that is a reinforcement fiber arranged in the inside of the same porous body 6, located between end faces of an axial line direction thereof and linearly and continuously buried in parallel with the axial line.

Three multi-filament yarns 7 along the axial direction of the hollow fiber are arranged at a certain phase difference in the porous body 6. The porous body 5 is constituted by arranging a region A in which the multifilament yarns 7 exist in a circumferential direction thereof and a region B in which the multi-filament yarns 7 do not exist alternately.

Although the porous body 5 according to the present embodiment has three linear reinforcement fibers along the axial direction of the hollow fiber, a lattice-shaped or a spiral shaped reinforcement fiber may be additionally provided in a direction which obliquely crosses the linear reinforcement fiber.

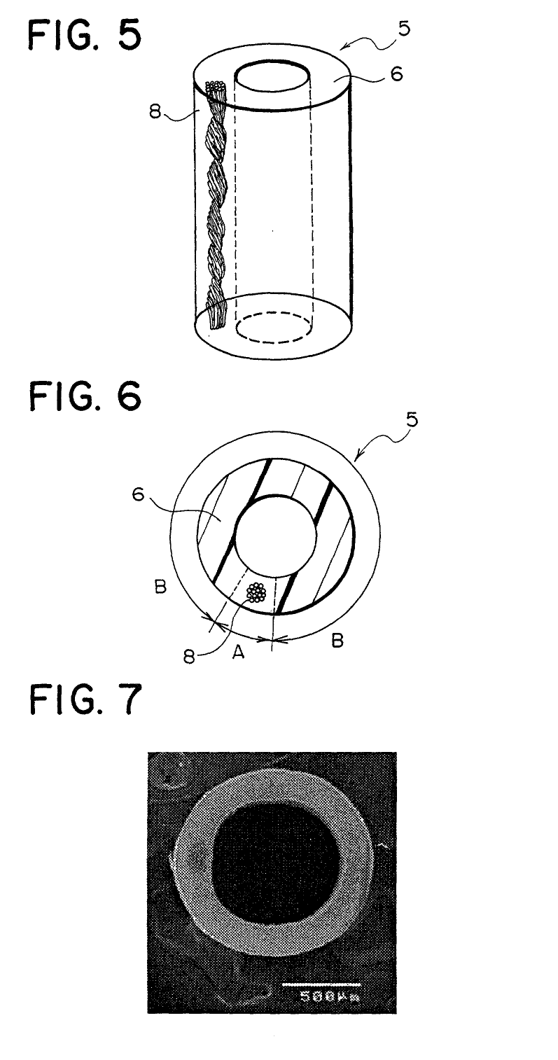

FIG. 5 is a perspective view by seeing through the inside of another preferable porous membrane 5 according to the present invention, and FIG. 6 is a sectional view of the same porous membrane 5.

The porous membrane 5 shown in FIG. 5 and FIG. 6 is a hollow fiber shape. The porous membrane 5 according to the present embodiment is composed of a porous body 6 having a number of pores penetrated from a hollowed inside of the hollow fiber to the outside of the hollow fiber, and a spun yarn 8 that is a reinforcement fiber arranged in the inside of the same porous body 6, located between end faces of an axial line direction thereof and linearly and continuously buried in parallel with the axial line.

One spun yarn 8 is arranged in the porous body 6 along the axial direction of the hollow fiber. The porous body 5 is constituted by arranging a region A in which the spun yarn 8 exists in a circumferential direction and a region B in which the same spun yarn 8 does not exist to be adjacent to each other.

As in this example, when a spun yarn is used as the reinforcement fiber, individual staple fibers which constitute the spun yarn are not always continuous in the axis direction of the hollow fiber. However, since the spun yarn as an assembled body of fiber is continuous, a sufficient tensile/rupture strength can be given to the hollow fiber membrane by burying the spun yarn linearly and continuously in parallel to the axis direction of the hollow fiber membrane.

When the spun yarn is used, the reinforcement fiber in the present invention is not an individual fiber which constitutes a spun yarn, but a single reinforcement fiber is composed of a spun yarn which is an assembled body of staple fibers. The same can be applied to a multi-filament. The reinforcement fiber in the present invention is not an individual filament which constitutes the multi-filament, but a single reinforcement fiber is a number of filaments which are the assembled body of filaments.

Each of the porous membranes 1 and 5 according to the present embodiment as shown in the FIG. 1 to FIG. 6 is constituted by arranging a portion A which is reinforced by the reinforcement fibers 3, 7 and 8 and a portion B which is not reinforced by the reinforcement fibers 3, 7 and 8 alternately. Further, since an interval of adjacent reinforcement fibers 3, 7 and 8 is set at such a distance that the lowering of the permeation performance does not occur, namely, projection areas of the reinforcement fibers 3, 7 and 8 with respect to the porous bodies 2 and 6 are set at 20% or less. Therefore, a superior permeation performance can be kept without vainly raising the permeation resistance of the porous membranes. Further, as described above, since the reinforcement fibers 3,7 and 8 are arranged, the superior permeation performance can be kept while a sufficient mechanical strength which is required for a filtration membrane can be obtained.

In addition, in the present invention, the number of the spun yarns, the multi-filament yarns, the monofilament yarns and the like, which are the reinforcement fibers, may be a single or plural. It can be changed in accordance with physical properties required for the use of an object. Further, in the illustrated embodiment, the reinforcement fibers 3,7 and 8 are completely buried in the inside of the porous bodies 2 and 6. However, it should not be limited to this, as far as part of the reinforcement fibers exists in the inside of the porous body. However, from the viewpoint of completeness of the membrane separation and the improvement of mechanical physical property, it is preferable that the fiber is completely buried in the inside of the porous body.

Next, the fiber-reinforced porous membrane of the present invention will be specifically described with reference to preferable Examples. Further, it is a matter of course that the present invention should not be limited to Examples below.

### (Example 1)

An acryl fiber spun yarn (thickness: about 100 μm, tensile/rupture strength: 2.7N, tensile/rupture ductility: 42%) was stretched in a lattice shape with interval of 2 mm on a glass flat plate. A polymer solution composed of 15 parts by mass of polyacrylonitrile, 5 parts by mass of polyvinyl pyrrolidone (K-90, manufactured by ISP Co., Ltd.), 1 part by mass of water, and 79 parts by mass of N,N-dimethylacetamide was homogeneously flown on the glass plate so as to be a thickness of 200 μm, and then immediately, the glass plate was immersed in a coagulation liquid at 40° C. which is composed of 40 parts by mass of N,N-dimethylacetamide and 60 parts by mass of water, thus obtaining a coagulated membrane. Successively, the coagulated membrane was washed with hot water to remove the solvent, and then dried, so that a porous membrane could be obtained.

The tensile/rupture strength of the obtained porous membrane was 12 MPa, and the tensile/rupture ductility was about 40%. Further, the proportion at which the projection area of the reinforcement fibers to the membrane face occupies the membrane area was 19%.

### (Example 2)

15 Parts by mass of polysulfone (UDEL P-3500, manufactured by Teijin-Amoco Engineering Co., Ltd.), 8 parts by mass of polyvinyl pyrrolidone (K-90, manufactured by ISP Co., Ltd.), and 2 parts by mass of water were dissolved in 75 parts by mass of N,N-dimethylacetamide by heating and stirring at 80° C. The spinning raw solution and three polyester multifilaments (56dtex/24fil., tensile/rupture strength: 4.4 N, tensile/rupture ductility : 60%) were discharged from a sheath part of a double ring nozzle having an outer diameter of 2.0 mm and an inner diameter of 1.2 mm and kept at a temperature of 60° C., and at the same time, an inner coagulation liquid which is composed of 90 parts by mass of N,N-dimethylacetamide and 10 parts by mass of water was discharged from the core part of the same nozzle, and the discharged article was introduced in a coagulation bath at 50° C. consisting of water which was set at 3 cm lower from the discharge face of the nozzle. Thus, a hollow fiber-shaped-fiber-reinforced porous membrane can be obtained. This hollow fiber shaped fiber-reinforced porous membrane was washed with hot water, and then dried at 120° C.

The outer diameter/inner diameter of the obtained hollow fiber shaped-fiber-reinforced porous membrane was about 0.8/0.5 mm, the bubble point was 200 kPa, the pure water permeation coefficient indicating a water permeation performance was 110 m³/m²/hr/MPa, the tensile/rupture strength was 40 MPa, and the tensile/rupture ductility was about 45%. The tensile moduluses of the three polyester multi-filaments as the reinforcement fibers were respectively about 2.1 GPa. These fibers were completely buried in the inside of the porous body. Further, the proportion at which the projection area of the reinforcement fibers to the membrane face occupies the membrane area was 8%.

### (Example 3)

18 Parts by mass of polyvinylidene fluoride (KAINER 460, manufactured by ATOSHINA JAPAN Co., Ltd.), and 9 parts by mass of polyvinyl pyrrolidone (K-90) were dissolved in 73 parts by mass of N,N-dimethylacetamide by heating and stirring at 80° C. The spinning raw solution and one polyester multifilament (110dtex/48fil., tensile/rupture strength: 4.7 N, tensile/rupture ductility: 50%) were discharged from a sheath part of a double ring nozzle having an outer diameter of 1.6 mm and an inner diameter of 0.8 mm and kept at a temperature of 30° C., and at the same time, an inner coagulation liquid which is composed of 30 parts by mass of N,N-dimethylacetamide, 30 parts by mass of water and 40 parts by mass of glycerin was discharged from the core part of the same nozzle. The discharged article was introduced in a coagulation bath at 65° C. consisting of 30 parts by mass of N,N-dimethylacetamide and 70 parts by mass of water, which was set at 4 cm lower from the discharge face of the nozzle. Thus, a hollow fibershaped-fiber-reinforced porous membrane could be obtained. This hollow fiber-shaped-fiber-reinforced porous membrane was washed with hot water, and then dried at 80° C.

The outer diameter/inner diameter of the obtained hollow fiber-shaped-fiber-reinforced porous membrane was about 1.2/0.8 mm, the bubble point was 60 kPa, the pure water permeation coefficient indicating water permeation performance was 450 m³/m²/hr/MPa, the tensile/rupture strength was 11 MPa, and the tensile/rupture ductility was about 40%. The tensile modulus of the polyester multifilament as the reinforcement fiber was about 2.1 GPa. The fiber was completely buried in the inside of the porous body. Further, the proportion at which the projection area of the reinforcement fiber to the membrane face occupies the membrane area was 4%. FIG. 7 is a sectional photo of the hollow fiber membrane as thus obtained.

### (Example 4)

A hollow fiber shape fiber-reinforced porous membrane was produced under the same condition as in Example 3 except that polyvinylidene fluoride was replaced with KAINER 301F (manufactured by ATOSHINA JAPAN Co., Ltd.), the number of the reinforcement fiber was two, and a coagulation liquid in a coagulation bath was composed of 30 parts by mass of N,N-dimethylacetamide and 70 parts by mass of water at 65° C.

The outer diameter/inner diameter of the obtained hollow fiber-shaped-fiber-reinforced porous membrane was about 1.2/0.85 mm, the bubble point was 70 kPa, the pure water permeation coefficient indicating water permeation performance was 370 m³/m²/hr/MPa, the tensile/rupture strength was 21 MPa, and the tensile/rupture ductility was about 40%. The tensile moduluses of the two polyester multifilaments as the reinforcement fibers were respectively about 2.1 GPa. These fibers were completely buried in the inside of the porous body. Further, the proportion at which the projection area of the reinforcement fibers to the membrane face occupies the membrane area was 8%.

### (Example 5)

A hollow fiber-shaped-fiber-reinforced porous membrane was produced under the same condition as in Example 3 except that polyvinylidene fluoride was replaced with KAINER 301F (manufactured by ATOSHINA JAPAN Co., Ltd.), and a coagulation liquid in a coagulation bath was composed of 5 parts by mass of N,N-dimethylacetamide and 95 parts by mass of water at 70° C.

The outer diameter/inner diameter of the obtained hollow fiber-shape-fiber-reinforced porous membrane was about 1.2/0.8 mm, the bubble point was 124 kPa, the pure water permeation coefficient indicating water permeation performance was 292 m³/m²/hr/MPa, the tensile/rupture strength was 12 MPa, and the tensile/rupture ductility was about 40%. The tensile moduluses of the three polyester multifilaments as the reinforcement fibers were respectively about 2.1 GPa. These fibers were completely buried in the inside of the porous body. Further, the proportion at which the projection area of the reinforcement fibers to the membrane face occupies the membrane area was 4%.

### (Example 6)

A hollow fiber-shaped-fiber-reinforced porous membrane was produced under the same condition as in Example 3 except that polyvinylidene fluoride was replaced with KAINER 301F (manufactured by ATOSHINA JAPAN Co., Ltd.), the number of the reinforcement fibers was three, and a coagulation liquid in a coagulation bath was 5 parts by mass of N,N-dimethylacetamide and 95 parts by mass of water at 70° C.

The outer diameter/inner diameter of the obtained hollow fiber-shaped-fiber-reinforced porous membrane was about 1.2/0.8 mm, the bubble point was 100 kPa, the pure water permeation coefficient indicating water permeation performance was 315 m³/m²/hr/MPa, the tensile/rupture strength was 32 MPa, and the tensile/rupture ductility was about 40%. The reinforcement fibers were completely buried in the inside of the porous body. Further, the proportion at which the projection area of the reinforcement fibers to the membrane face occupies the membrane area was 12%.

### (Example 7)

A hollow fiber-shaped-fiber-reinforced porous membrane was produced under the same condition as in Example 4 except that the reinforcement fiber was monofilament of polyvinylidene fluoride (diameter: about 70 μm, tensile/rupture strength: 3.8 N, tensile/rupture ductility 52%).

The obtained outer diameter/inner diameter of the hollow fiber-shaped-fiber-reinforced porous membrane was about 1.2/0.8 mm, the bubble point was 60 kPa, the pure water permeation coefficient indicating water permeation performance was 420 m³/m²/hr/MPa, the tensile/rupture strength was 10 MPa, and the tensile/rupture ductility was about 40%. Further, the fiber was completely buried in the inside of the porous body. Further, the proportion at which the projection area of the reinforcement fibers to the membrane face occupies the membrane area was 2%.

### (Comparative Example 1)

A hollow fiber-shaped porous membrane was produced in the same manner as in Example 2, except that only the spinning raw solution was discharged from the sheath part of a double ring nozzle and the polyester multifilament was not used in Example 2.

The outer diameter/inner diameter of the obtained hollow fiber-shaped porous membrane was about 0.8/0.5 mm, and the bubble point was about 200 kPa. The pure water permeation coefficient indicating water permeation performance was 120 m³/m²/hr/MPa, the tensile/rupture strength was 2.7 MPa, and the tensile/rupture ductility was about 48%. Although this water permeation performance of the porous membrane is only slightly larger than the water permeation performance of the porous membrane obtained in the Example 2, the tensile/rupture strength was sharply lower than that of Example 2. As a result, it could not be endured for practical use.

### (Comparative Example 2)

A hollow fiber-shaped porous membrane was produced in the same manner as in Example 6, except that only the spinning raw solution was discharged from the sheath part of a double ring nozzle and the polyester multifilament was not used in Example 6. The tensile modulus of the porous membrane is only about 0.04 GPa.

The outer diameter/inner diameter of the obtained hollow fiber shape porous membrane was about 1.2/0.8 mm, and the bubble point was 134 kPa. The pure water permeation coefficient indicating water permeation performance was 276 m³/m²/hr/MPa, the tensile/rupture strength was 3 MPa, and the tensile/rupture ductility was about 100%. Although this water permeation performance of the porous membrane is only slightly less than the water permeation performance of the porous membrane obtained in the above-mentioned Example 6, the tensile/rupture strength was considerably lower than that of Example 6. As a result, it could not be endured for practical use.

As being apparent from Examples and Comparative Examples as described above, since the reinforcement fiber is linearly and continuously buried between end parts orthogonal to the permeation direction of the porous body and the porous body has both a portion in which the reinforcement fiber is buried and a portion in which the reinforcement fiber is not buried, the porous membrane according to the present invention can secure superior permeation and separation performances and improve its strength by the reinforcement fiber. Accordingly, filtration and separation by the membrane method can be carried out by using the porous membrane of the present invention, in a severe use condition such as various water treatments and the like, under which was considered difficult to perform filtration and separation by a conventional membrane method. Therefore, it can be realized to improve a quality of a filtrate (water) and compact a facility thereof.

1. A porous membrane comprising a porous body having a number of pores communicated from one surface to the other surface, and a reinforcement fiber, characterized in that
at least one reinforcement fiber is linearly arranged penetrating both opposite ends orthogonal to a permeation direction of the porous body, a part of the fiber is exposed to the surface of the porous body or all of the fiber is buried in the porous body to be continuously extended, and
a region which contains a cross-section of the fiber and a region which does not contain the cross section exist on a section of the porous body orthogonal to an extension direction of the fiber.

2. A porous membrane according to claim 1, characterized in that the porous body is a hollow fiber shape and the reinforcement fiber is arranged in parallel to a hollow axis line direction.

3. A porous membrane according to claim 1 or 2, characterized in that the porous body is a flat plate shape, and the reinforcement fiber is arranged orthogonally to a permeation direction between opposite end faces thereof.

4. A porous membrane according to any one of claims 1 to 3, characterized in that the porous body is an inclined-type three dimensional network structure comprising a dense layer which has a separation characteristic and a supporting layer contiguous to the dense layer in which the pore diameter increases gradually.

5. A porous membrane according to any one of claims 1 to 4, characterized in that the porous body is composed of fluorine-based resin.

6. A porous membrane according to any one of claims 1 to 5, characterized in that the porous body is composed of polyvinylidene fluoride-based resin.

7. A porous membrane, characterized in that a relation of a pure water permeation coefficient of a porous body with a bubble point when ethyl alcohol was used as a measurement medium satisfies the following equation (I) and the tensile/rupture strength is 10 MPa or more:
WF≧10000/BP (I)
wherein WF denotes a pure water permeation coefficient (m³/m²/hr/MPa), and BP denotes a bubble point (kPa).

8. A porous membrane according to claim 7, characterized in that the bubble point is 50 kPa or more.

9. A porous membrane according to any one of claims 1 to 8, characterized in that the reinforcement fiber is any one of a monofilament, a multifilament and a spun yarn.

10. A porous membrane according to any one of claims 1 to 9, characterized in that the reinforcement fiber has any one of a round section, a hollow structure and a varied section.

11. A porous membrane according to any one of claims 1 to 10, characterized in that the reinforcement fiber is composed of one of a natural fiber, a semi-synthetic fiber, a synthetic fiber, a regenerated fiber, and an inorganic fiber, or a combination thereof.

12. A porous membrane according to any one of claims 1 to 11, characterized in that the reinforcement fiber is composed of polyester-based resin.

13. A porous membrane according to any one of claims 1 to 12, characterized in that a thickness of the reinforcement fiber is 10 to 300 μm.

14. A porous membrane according to any one of claims 1 to 13, characterized in that a tensile modulus of the reinforcement fiber is higher than a tensile modulus of the porous body.

15. A porous membrane according to claim 14, characterized in that the tensile modulus of the reinforcement fiber is two times or more as large as the tensile modulus of the porous body.

16. A porous membrane according to any one of claims 1 to 15, characterized in that the tensile modulus of the reinforcement fiber is 0.1 GPa or more.

17. A porous membrane according to any one of claims 1 to 14, characterized in that a tensile/rupture ductility of the porous body is higher than a tensile/rupture ductility of the reinforcement fiber.

18. A porous membrane according to claim 15, characterized in that the tensile/rupture ductility of the porous body is 1.2-times or more as large as the tensile/rupture ductility of the reinforcement fiber.

19. A porous membrane according to any one of claims 1 to 18, characterized in that the tensile/rupture ductility of the porous body is 30% or more.

20. A porous membrane according to any one of claims 1 to 19, characterized in that a projection area of the reinforcement fiber with respect to a membrane area of the porous body is 20% or less.
